(19) United States
(12) Patent Application Publication
(10) Pub. No.: US 2009/0173747 A1
(43) Pub. Date: Jul. 9, 2009

(54) BEAD CRAFT SYSTEM

(76) Inventor: Paul Andrew Reynolds, Toronto (CA)

Correspondence Address: HERMAN & MILLMAN, 141 ADELAIDE ST. WEST, SUITE 1002, TORONTO, ON, M5H 3L5, CA

(21) Appl. No.: 11/969,672

(22) Filed: Jan. 4, 2008

(51) Int. Cl. B65H 1/00; B65D 83/00; B05C 17/00

(52) U.S. Cl. 221/122; 221/92; 221/135; 206/1.7

(57) ABSTRACT

The invention is directed to a bead craft system for making a bead craft. The bead craft system may be used with beads that are wettable and subsequently dryable to adhere to one another. In one aspect, the bead craft system may include a bead storage and dispensing device including a bead storage chamber having a bead storage chamber wall defining a chamber outlet aperture and a bead outlet conduit external to the bead storage chamber wall. The bead outlet conduit has an inlet. The bead storage chamber wall is movable between an unaligned position wherein the chamber outlet aperture is unaligned with the inlet of the bead outlet conduit to prevent the release of beads from the bead storage chamber, and an aligned position wherein the chamber outlet aperture is aligned with the inlet of the bead outlet conduit to permit the release of at least one bead from the bead storage chamber.

### FIELD OF THE INVENTION

The present invention relates to bead craft systems and more particularly to bead craft systems incorporating beads that are wettable to adhere to each other.

### BACKGROUND OF THE INVENTION

Bead craft systems exist for making crafts using small beads that adhere to one another when wetted and then dried. One such bead craft system incorporates a work area for making a bead craft and a dispensing system above the work area with a bead conduit that transports beads down to a hand tool for placement of the individual beads in the work area. The bead dispensing system and the bead conduit in particular can obstruct the user's view of the work area, however.

The aforementioned bead craft system also incorporates a fan underneath the bead dispensing system for drying a bead craft. The user moves the bead craft from the work area to a position directly underneath the fan and turns the fan on to dry the bead craft. Unfortunately, however, the bead craft being dried partially occupies the bead craft work area, thus making if difficult to work on a new bead craft while drying a completed bead craft. Additionally, the fan is fixed in position and so it may be difficult to dry certain portions of a bead craft.

Additionally, the bead craft system does not lend itself to the formation of three-dimensional crafts, and therefore does not take full advantage of the capabilities of the beads.

It would be advantageous to provide a bead craft system that addresses one or more of the above noted disadvantages.

### SUMMARY OF THE INVENTION

In a first aspect, the invention is directed to a bead craft system with which a user can make a bead craft. The bead craft system includes a bead storage chamber having a bead storage chamber wall defining a chamber outlet aperture, and a bead outlet conduit external to the bead storage chamber wall. The bead outlet conduit has an inlet. The bead storage chamber wall is movable between an unaligned position wherein the chamber outlet aperture is unaligned with the inlet of the bead outlet conduit to prevent the release of beads from the bead storage chamber, and an aligned position wherein the chamber outlet aperture is aligned with the inlet of the bead outlet conduit to permit the release of at least one bead from the bead storage chamber.

In a second aspect, the invention is directed to a bead craft system, including a housing having a bead craft work area, a fan within the housing, and an air outlet conduit connectable to the housing and in fluid communication with and downstream from the fan for use in drying a craft. The conduit is movable to a plurality of positions.

In a third aspect, the invention is directed to a bead transfer device. The bead transfer device includes a bead transfer device body defining an interior volume. The bead transfer device body is deformable to reduce the volume of the interior volume, and is resilient. The bead transfer device body has a single opening. The opening is sized and shaped to form a seal on one of the beads.

In a fourth aspect, the invention is directed to a bead craft system including a housing having a bead craft work area that includes a planar bead craft tray configured to receive beads for producing a planar bead craft and a three-dimensional bead craft form positioned underneath the planar bead craft tray. The three-dimensional bead craft form is configured to receive beads for the formation of a three dimensional bead craft. The three-dimensional bead craft form may be positioned on (eg. molded in as part of) a three-dimensional bead craft tray, which is held in a three-dimensional bead craft tray receptacle, which is itself a second three-dimensional bead craft form.

In a fifth aspect, the invention is directed to a bead craft system including a housing having a bead craft work area including a bead craft work area, and at least one bead craft holder connected to the housing. Each bead craft holder includes a gripper and a gripper arm. The gripper arm is configurable to position the gripper in a plurality of positions. The gripper arm may be an air flow conduit for transporting air from a fan positioned inside the housing, so that a bead craft held by the gripper may be dried using air from the air flow conduit.

### BRIEF DESCRIPTION OF THE DRAWINGS

The present invention will now be described by way of example only with reference to the attached drawings, in which:

FIG. 1 is a perspective view of a bead craft system in accordance with an embodiment of the present invention;

FIG. 2 is a sectional view of the bead craft system shown in FIG. 1;

FIG. 3a is a sectional view of a portion of a bead storage and dispensing system that is part of the bead craft system shown in FIG. 1, in a first position;

FIG. 3b is a sectional view of the portion of a bead storage and dispensing system shown in FIG. 3a, in a second position;

FIG. 4 is a plan view of a bead storage unit that is part of the bead craft system shown in FIG. 1;

FIG. 5 is a perspective view of a bead storage unit support that is part of the bead craft system shown in FIG. 1;

FIG. 6 is a perspective view of the bead storage unit shown in FIG. 4;

FIG. 7 is a sectional perspective view of the bead storage unit support shown in FIG. 5;

FIG. 8 is a sectional perspective view of the bead craft system shown in FIG. 1;

FIG. 9 is a sectional elevation view of a bead transfer device that is part of the bead craft system shown in FIG. 1;

FIG. 10 is a perspective view of a bead craft drying system that is part of the bead craft system shown in FIG. 1;

FIG. 11 is an elevation view of the bead craft system shown in FIG. 1;

FIG. 12 is a perspective view of the bead craft shown in FIG. 1, in a pose where a first bead craft is being joined to a second bead craft;

FIGS. 13a and 13b are side and plan views of a gripper that is included in the bead craft system shown in FIG. 1;

FIG. 14 is a perspective view of the bead craft shown in FIG. 1, showing a plurality of three-dimensional bead craft forms that are used to produce three-dimensional bead crafts;

FIG. 15 is a sectional view of one of the three-dimensional bead craft forms shown in FIG. 14;

FIG. 16 is a perspective view of the bead craft shown in FIG. 1, showing a receptacle for the three-dimensional bead craft forms shown in FIG. 14;

FIG. 17 is a perspective view of a fan that makes up an alternatively bead craft drying system that can be used as part of the bead craft system shown in FIG. 1;

FIG. 18a is a sectional side elevation view of an indexing system that is optionally included with the bead craft system shown in FIG. 1;

FIG. 18b is a sectional side view through section lines 18b-18b in FIG. 18a; and

FIGS. 19a and 19b are sectional views illustrating the dispensing of a bead from a bead storage unit and bead storage unit support in accordance with an alternative embodiment of the present invention.

### DETAILED DESCRIPTION OF THE INVENTION

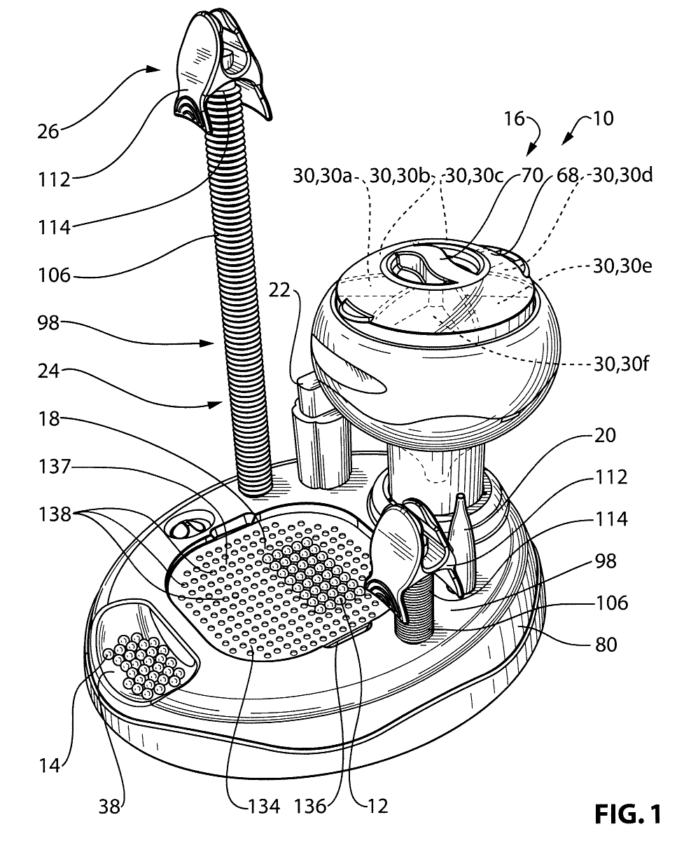

Reference is made to FIG. 1, which shows a bead craft system 10 in accordance with an embodiment of the present invention. The bead craft system 10 permits a user to create a bead craft 12 using beads 14. The beads 14 may be of the type that are wettable and subsequently dryable to cause them to adhere to one another, thereby forming a self-supporting craft, such as the craft 12.

The bead craft system 10 includes a bead storage and dispensing device 16, a bead craft work area 18, a bead transfer device 20, a bead wetting device 22, a bead craft drying system 24 and a plurality of bead craft holders 26.

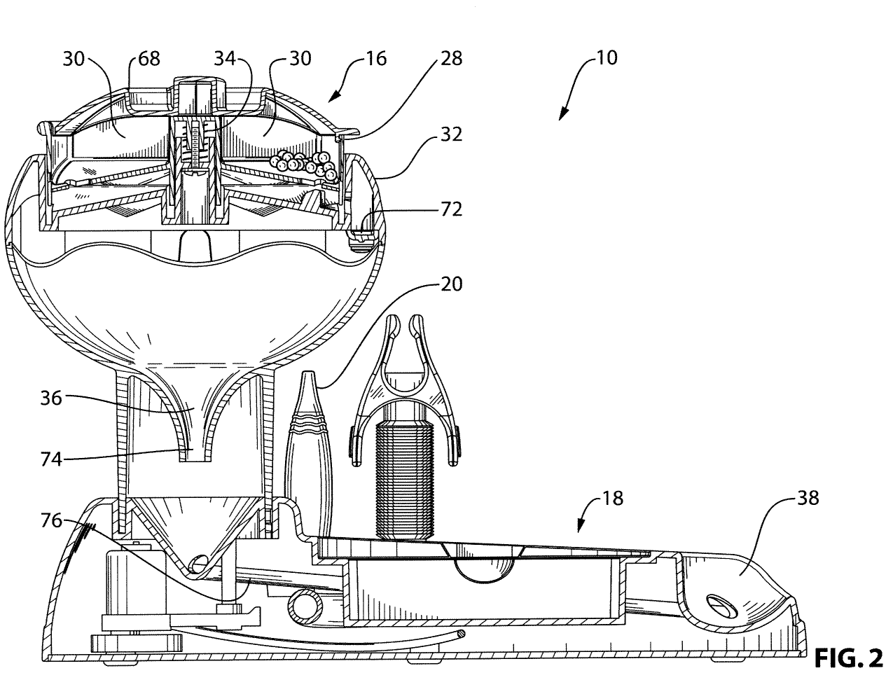

Reference is made to FIG. 2, which shows a sectional view of the bead craft system 10. The bead storage and dispensing system 16 includes a storage receptacle 28 that is divided into one or more bead storage chambers 30, a bead storage unit support 32, a bead storage unit biasing element 34, a bead outlet conduit 36, and a working reservoir 38. As shown in FIG. 1, there may be, for example, six bead storage chambers, shown at 30a, 30b, 30c, 30d, 30e and 30f.

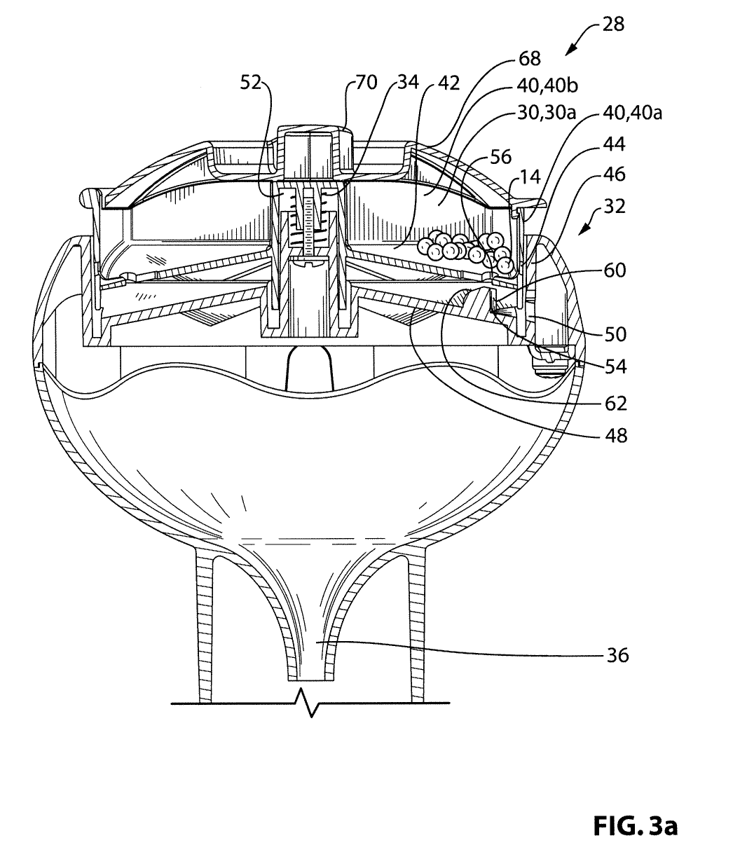

Referring to FIG. 3a, each bead storage chamber 30 is defined by one or more bead storage chamber walls 40 and a bead storage chamber floor 42. The bead storage chamber walls 40 may include, for example, an outer circumferential wall 40a and two radially extending walls 40b. A chamber outlet aperture 44 that may be sized to permit the pass-through of any suitable number of beads 14 at a time is defined in one of the walls 40, such as, for example, the outer circumferential wall 40a. For example, the chamber outlet aperture 44 may be sized to permit one bead 14 to pass through at a time. The bead storage unit support 32 supports the bead storage receptacle 28 and includes a storage unit support wall 46 and a storage unit support base 48. The storage unit support wall 46 defines an inlet 50 into the bead outlet conduit 36, which extends from the storage unit support wall 46 to the working reservoir 38, shown in FIG. 1.

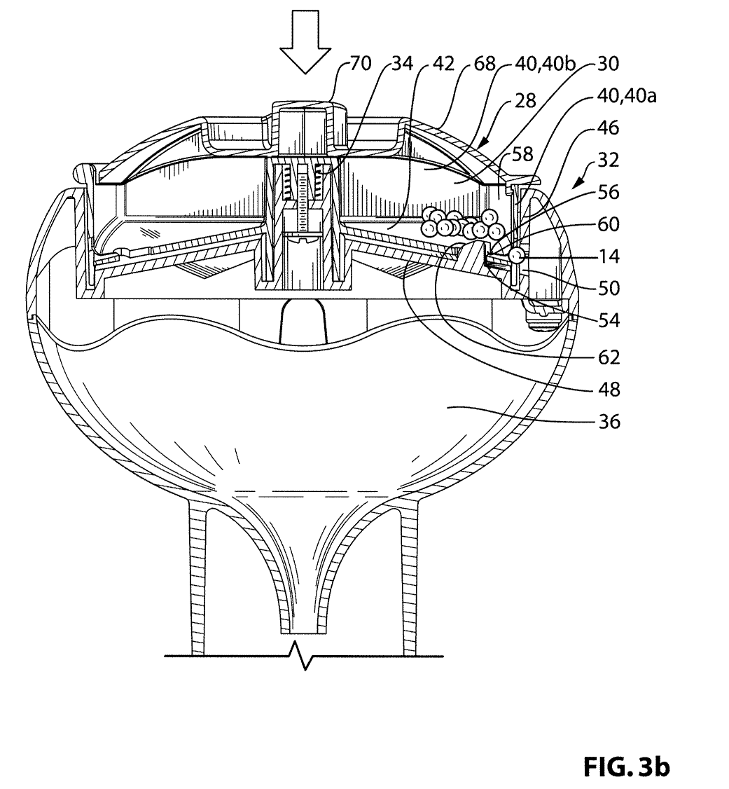

The bead storage unit 28 is movable between a first position (FIG. 3a), in which the chamber outlet aperture 44 is unaligned with the inlet 50 into the bead outlet conduit 36, thereby preventing the release of one or more beads 14 from the bead storage chamber 30, and a second position (FIG. 3b) in which the chamber outlet aperture 44 is aligned with the inlet 50, thereby permitting the release of one or more beads 14 from the bead storage chamber 30 into the bead outlet conduit 36. The first position (FIG. 3) may be referred to as the unaligned position. The second position (FIG. 4) may be referred to as the aligned position. The storage unit support 32 guides the movement of the bead storage unit 28 between the unaligned and aligned positions.

The bead storage unit biasing element 34 biases the bead storage unit 28 towards the unaligned position (FIG. 3a). The bead storage unit biasing element 34 may be any suitable type of biasing element, such as, for example, a compression spring that is positioned in a biasing element chamber 52.

The bead storage chamber floor 42 may be sloped towards the chamber outlet aperture 44 so as to direct beads 14 towards the outlet aperture 44. Alternatively, just a portion of the bead storage chamber floor 42 may be sloped towards the chamber outlet aperture 44, such as the portion of the floor 42 that is proximate the chamber outlet aperture 44, so as to direct beads 14 that are immediately adjacent the chamber outlet aperture 44 towards the outlet aperture 44.

An optional anti-bridging member 54 may be provided to inhibit the bridging of beads 14 at the chamber outlet aperture 44. Bridging is a term that describes a situation when two or more beads 14 are at the chamber outlet aperture 44, and the positioning and mutual engagement of the beads 14 prevents any one bead 14 from being discharged from the chamber outlet aperture 44. Thus, the beads 14 may be said to form a ‘bridge’ across the outlet aperture 44.

When the bead storage chamber 30 is in the unaligned position the anti-bridging member 54 extends upwards from the storage unit support base 48 to just under the bead storage chamber floor 42 the bead storage chamber 30. When the bead storage unit 28 is pushed downwards towards the support base 48 to the aligned position (FIG. 2), the anti-bridging member 54 passes through an anti-bridging member pass-through aperture 56 in the bead chamber floor 42 and extends upwards into the bead storage chamber 30. The anti-bridging member 54 is positioned and configured to cooperate with the bead storage chamber wall 40 to define a bead discharge chamber 58 (FIG. 4) at the chamber outlet aperture 44. The bead discharge chamber 58 is configured to hold one or more beads 14 in a position that inhibits bridging of the beads 14 at the chamber outlet aperture 44.

As shown in FIG. 4, for example, the bead discharge chamber 58 may be sufficiently narrow to prevent two beads 14 from being horizontally adjacent each other at the chamber outlet aperture 44. Thus only a single bead 14 that is at floor level (ie. that is in contact with the bead storage chamber floor 42), can be at the chamber outlet aperture 44, thereby inhibiting bridging.

The anti-bridging member 54 may have any suitable shape. For example, the anti-bridging member 54 may have a bead-discharge-chamber-defining wall 60 that is generally V-shaped. The anti-bridging member 54 may further include other structure, as shown at 62, for reinforcing the bead-discharge-chamber-defining wall 60.

The anti-bridging member pass-through aperture 56 is preferably too small to permit the beads 14 to lodge therein, or to pass therethrough.

For the embodiment shown in FIGS. 2 and 3, when the bead storage unit 28 is pressed downwards to the aligned position, one bead (ie. the bead 14a) passes through the bead chamber outlet aperture 44 into the bead outlet conduit 36. If there are any beads 14 that were on top of the bead 14a, those beads 14 may drop down so that a new bead, shown at 14b, is positioned at the bead chamber outlet aperture 44. If the bead storage unit 28 remains in the aligned position, the new bead 14b can pass-through the bead chamber outlet aperture 44 into the bead outlet conduit 36. If this is undesirable, the bead storage unit 28 is preferably released to return under the force of the bead storage unit biasing element 34 to its unaligned position immediately after releasing a bead 14.

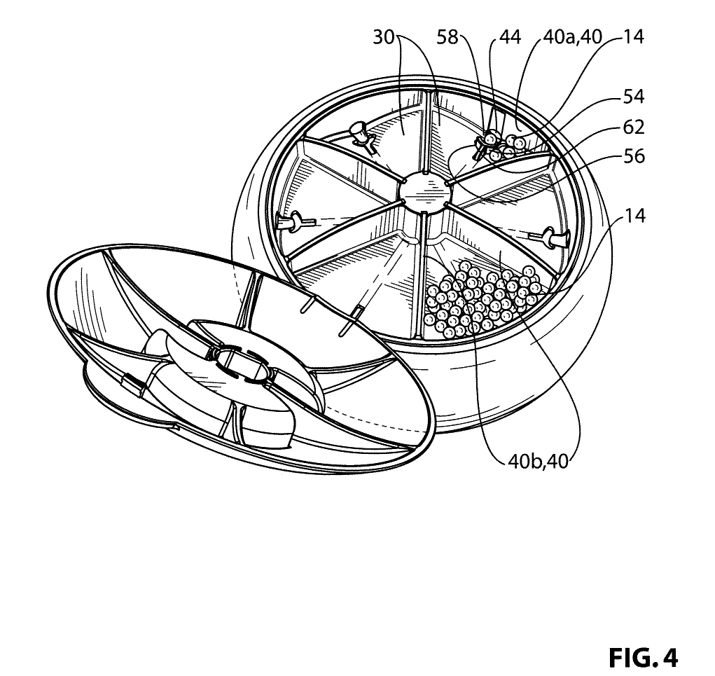

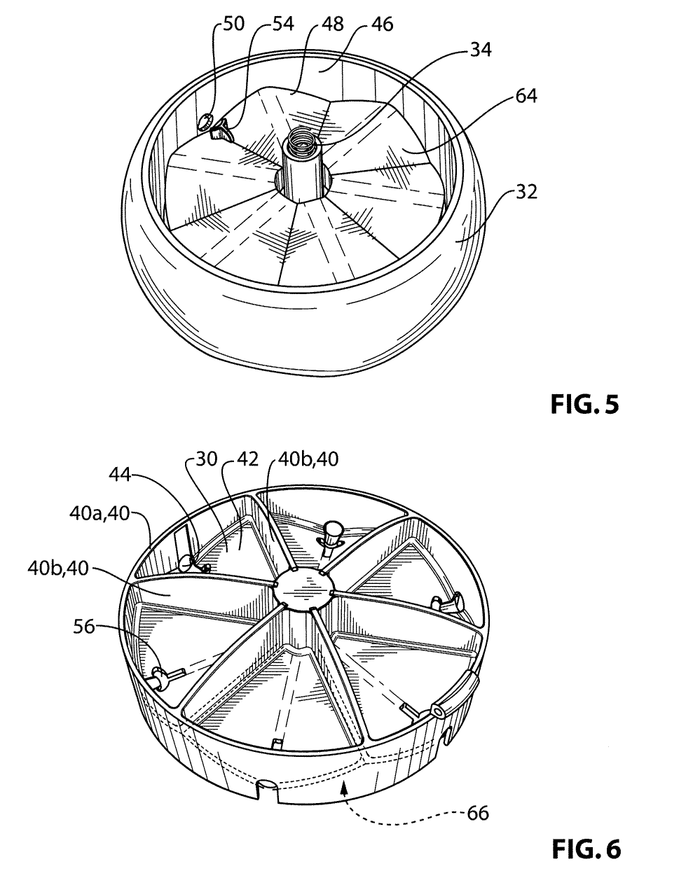

Referring to FIG. 1, in embodiments wherein the bead storage unit 28 is divided into a plurality of bead storage chambers 30, the bead storage unit 28 may be rotatable to bring a selected bead storage chamber 30 into position for releasing beads 14 into the bead outlet conduit 36. In order to ensure that the bead storage unit 28 is oriented properly on the bead storage unit support 32 so that a selected chamber outlet aperture 44 is correctly positioned to be aligned with the inlet 50 of the bead outlet conduit 36, the support base 48 of the bead storage unit support 32 has undulations 64 thereon (FIG. 5), which mate with undulations 66 (FIG. 6) on the underside of the bead storage unit 28. There may be one undulation 64 on the bead storage unit 28 for each bead storage chamber 30. The undulations 64 and 66 thus serve as an indexing system for the bead storage unit 28.

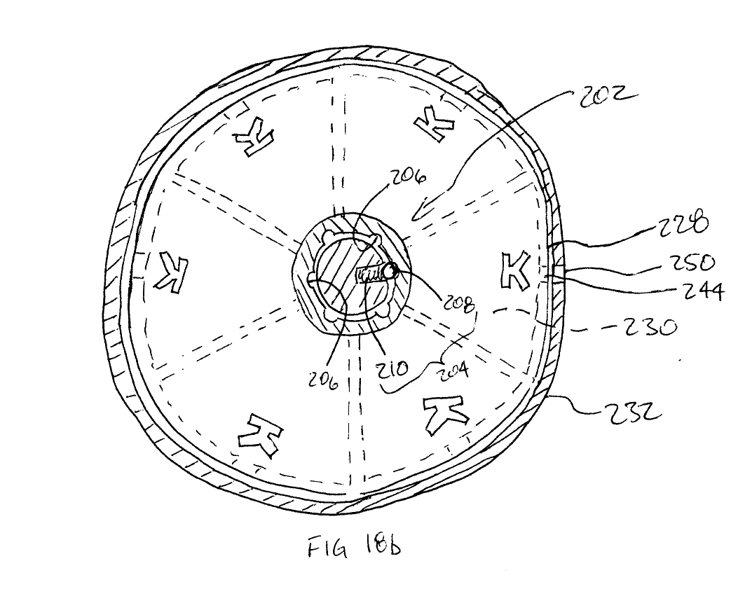

Other types of indexing system may alternatively be provided. Reference is made to FIGS. 18a and 18b which show an alternative indexing system 202 that may be provided. The indexing system 202 is for use with a bead storage unit 228 and a bead storage unit support 232, which may be similar to the bead storage unit 28 (FIG. 3a) and the bead storage unit support 32 respectively. The indexing system 202 includes a plunger 204 that is included in the bead storage unit support shown at 232, and a set of detents 206 that are included in the bead storage unit shown at 228. The plunger 204 includes a ball 208, or some other suitable projection, and biasing means 210 to urge the ball 208 to project outwards from the side of a central hub 212 on the bead storage unit support 232. The set of detents 206 is more clearly shown in FIG. 18b. Each detent 206 corresponds to one of the chambers 30, in the sense that each detent is engageable with the plunger 204 to position one of the chamber outlet apertures shown at 244 in circumferential alignment with the inlet 250 (see FIG. 18b) into the bead outlet conduit so that the bead storage unit 228 can be depressed axially to dispense a bead 14 (FIG. 18a) onto the ramp 272.

The bead storage unit biasing means 234 may be provided to bias the bead storage unit 228 for similar purpose to the bead storage unit biasing element 34 shown in FIG. 3a.

Referring to FIG. 1, the bead storage unit 28 may include a cover 68 for covering the bead storage chambers 30. The cover 82 may mount to one or more of the bead storage chamber walls 40 in any suitable way. The cover 82 may include a handgrip 84 that a user can use to rotate the bead storage unit 28.

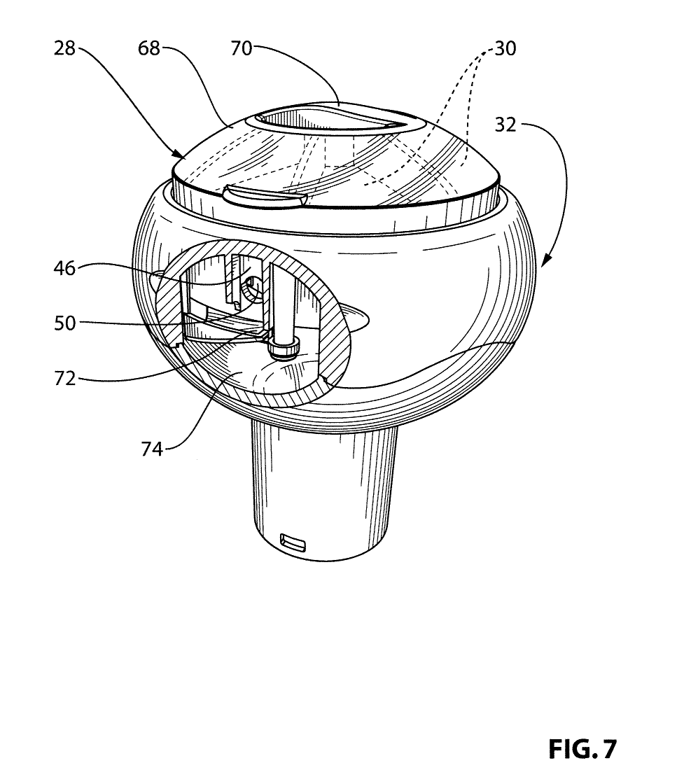

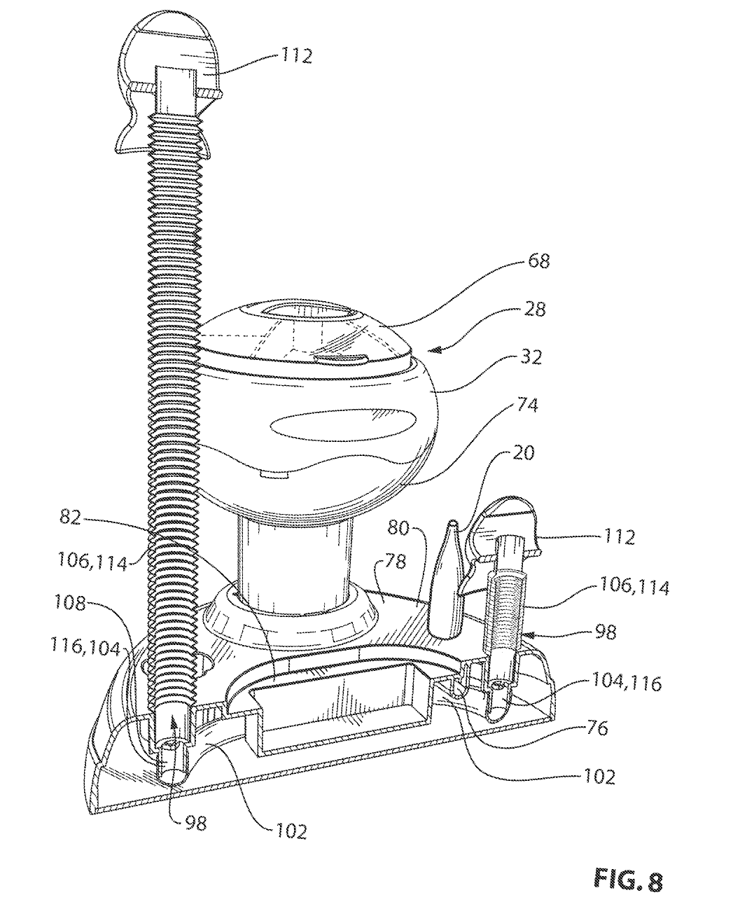

Referring to FIG. 2, the bead outlet conduit 36 conveys beads 14 from the bead storage chamber 30 to the working reservoir 38. The bead outlet conduit 36 includes an inlet ramp 72 (shown best in FIG. 7), a funnel segment 74 and a work area bypass segment 76. The inlet ramp 72 carries the beads 14 from the inlet 50 and is configured to direct the beads 14 at a selected angle and speed along the interior wall of the funnel portion 74. The beads 14 travel along a descending spiral path in the funnel portion 74, which is clear so that their travel is visible to a user, so as to provide entertainment value. The work area bypass segment 76 carries beads 14 from the funnel portion 74, around the bead craft work area 18, to the working reservoir 38. The work area bypass segment 76 may extend internally under the top surface, shown at 78, of the bead craft system housing, shown at 80 (see FIG. 8).

Referring to FIG. 2, it will be appreciated that the work area bypass segment 76 transports the beads 14 past the bead craft work area 18 to the working reservoir 38 for convenient access by the user without obstructing the user's view of the bead craft work area 18. This is achieved because the work area bypass segment 76 extends no higher than the upper surface of the bead craft work area 18, shown at 82. While the work area bypass segment 76 is shown in FIG. 2 to extend internally, it is alternatively possible for the work area bypass segment 76 to be an exposed, ie. open, channel (not shown) that is molded into the upper surface 78 of the bead craft system housing 80.

The working reservoir 38 may be an open reservoir that is positioned at the front of the bead craft system 10, for holding dispensed beads 14 for the user to use when making the craft 12 (FIG. 1).

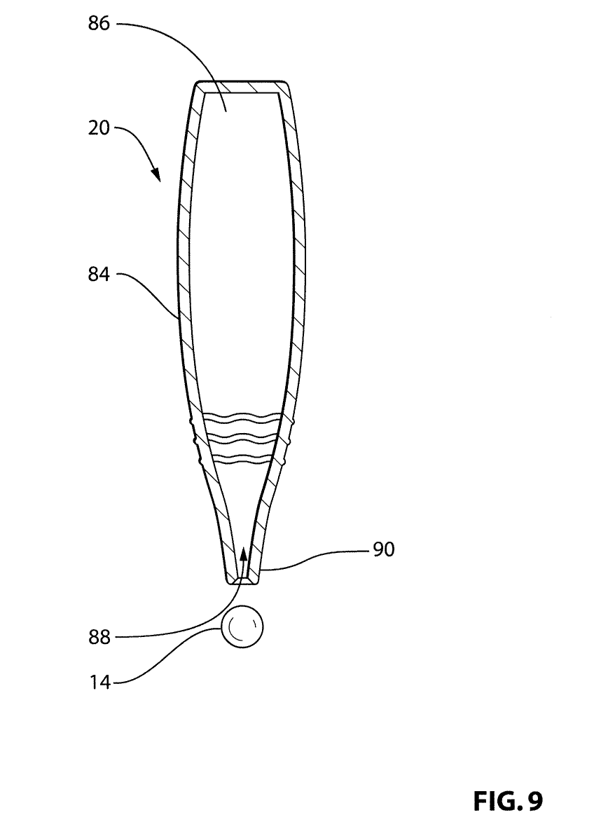

To pick up the beads 14 and position them when making a bead craft 12, the bead transfer device 20 may be used. An exemplary bead transfer device 20 is shown in detail in FIG. 9. The bead transfer device 20 may have a bead transfer device body 84 that defines an interior volume 86 and is deformable and resilient. The bead transfer device body 84 has a single opening 88 into the interior volume 86, which may be positioned on a tip, shown at 90. The opening 88 is sized and shaped to form a seal on a bead 14. The material of construction of the bead transfer device 20 at least around the opening 88 may be selected to be sufficiently soft to facilitate the formation of a seal with a bead 14.

To pick up a bead 14, the bead transfer device 20 is squeezed, and the tip 90 is then placed against the bead 14 to form a seal between the opening 88 and the bead 14. Suction holds the bead 14 against the opening 88. The bead 14 can then be picked up and moved to a desired position. To release the bead 14, the user squeezes the bead transfer device 20 again, thereby stopping the suction.

Put another way and without being restricted to theory, to pick up a bead 14 the bead transfer device 20 is squeezed to reduce the amount of air held in the interior volume 86. The opening 88 is put in contact with a bead 14 such that the bead 14 forms a seal against the opening 88 thereby preventing air from entering the interior volume 86 from outside the bead transfer device 20. The resilience of the bead transfer device body 84 urges the bead transfer device body 84 towards its rest state (ie. its uncompressed state). As the bead transfer device body 84 moves towards its rest state, the volume of the interior volume 88 increases, and correspondingly the air pressure in the interior volume 88 drops. The force on the bead transfer device body 84 from the differential pressure between the exterior of the bead transfer device body 84 and the interior volume 88 eventually reaches equilibrium with the force on the bead transfer device body 84 resulting from the resiliency of the material itself. At this aforementioned equilibrium, the air pressure in the interior volume is at some level that is less than the ambient air pressure. As a result, the differential air pressure urges the bead 14 into contact against the opening 86 thereby maintaining the seal between them. The force resulting from the differential pressure on the bead 14 keeps the bead 14 in contact with the opening 86, and is sufficiently strong that the bead 14 can be lifted in the air. For example, a bead 14 may be lifted up from the working reservoir 38. To release the bead 14, the bead transfer device 20 positions the bead 14 on a suitable surface, eg. in the bead craft work area 18, and the user squeezes the bead transfer device body 84 sufficiently to increase the air pressure inside the interior volume 86 until the differential pressure on the bead 14 is too weak to hold the bead 14 in contact with the opening 86 against the force of gravity.

The bead transfer device body 84 may be fabricated by any suitable method, such as by a molding process, and may be an integral piece.

The tip 90 of the bead transfer device 20 has a tip diameter that is preferably at most equal to the diameter of a bead 14. This permits the bead transfer device 20 to pick up a bead 14 that is positioned immediately adjacent other beads 14 without disturbing the other beads 14. For example, if the user decides to remove a bead 14 from a bead-craft-in-progress the user can pick up the bead 14 without disturbing the other beads 14 in the bead-craft-in-progress.

Referring to FIG. 1, once the beads 14 are positioned as desired in the bead craft work area 18, the bead wetting device 22 may be used to wet the beads 14, which is a first step in causing them to adhere to one another. The bead wetting device 22 may be any suitable type of device, such as, for example a spray bottle.

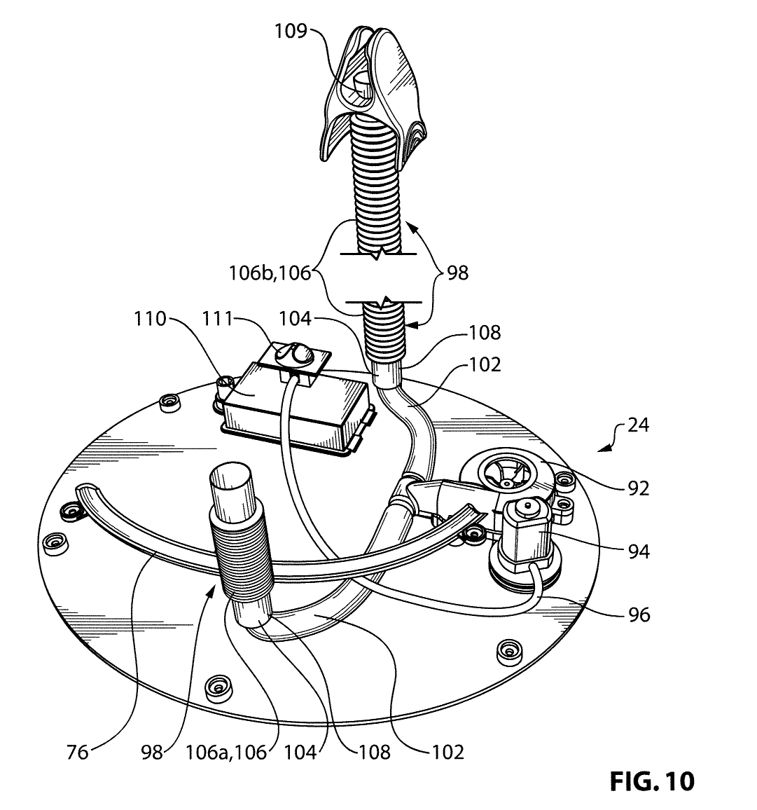

After the beads 14 in the bead craft work area 18 have been wetted, they may be dried, which is the second step in causing them to adhere to one another. The drying of the wetted beads 14 may be achieved by any suitable means. For example, the bead craft system 10 may include the bead craft drying system 24, which is shown in FIG. 10. The bead craft drying system 24 may include a fan 92, a fan motor 94 for driving the fan 92, an electrical conduit 96 for bringing electricity to the fan motor 94, and one or more air outlet conduits 98.

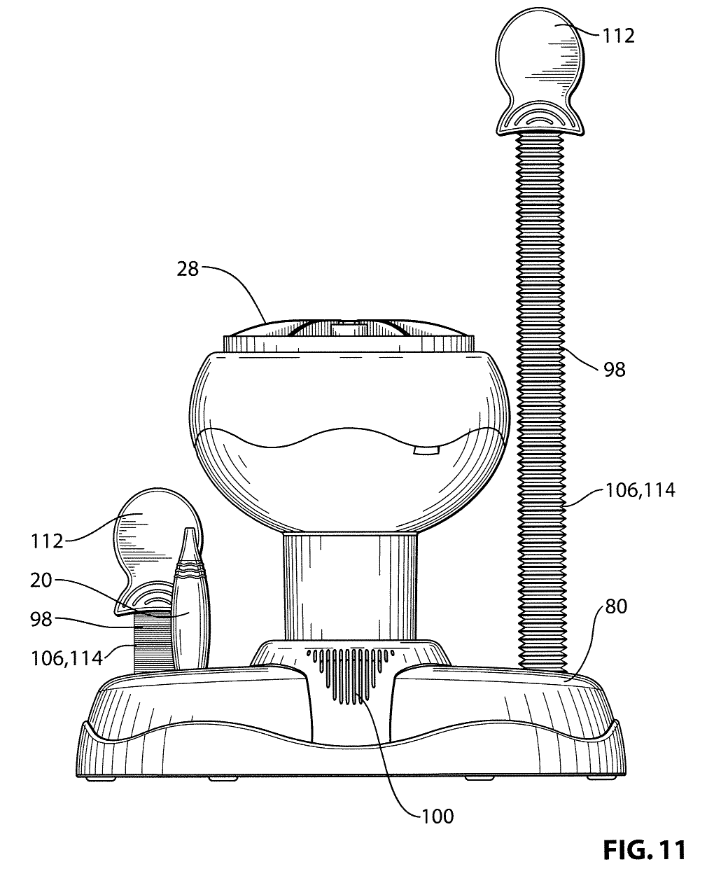

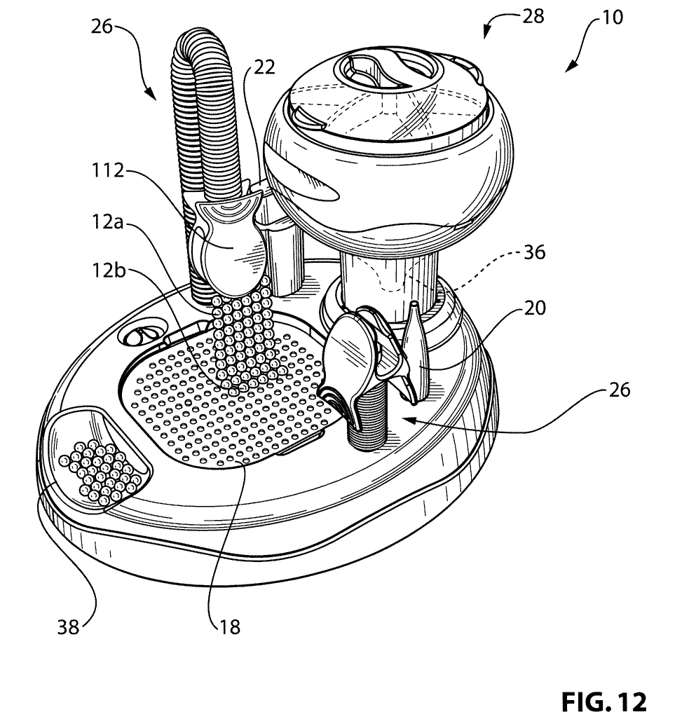

In the embodiment shown in FIG. 10, the fan 92 draws air from an inlet 100 in the housing 80 (see FIG. 11), and discharges the air to two air outlet conduits 98. Each air outlet conduit 98 includes an internal air outlet conduit 102 that is internal to the housing 80 that terminates at an air outlet port 104 (see FIG. 8) in the housing 80, and an external air outlet conduit 106 that is external to the housing 80 and that has an inlet end 108 that mounts to the port 104. The external air outlet conduit 106 may be made to be flexible so that it can be bent to select where on the bead craft 12 to direct drying air. The external air conduit 106 is preferably flexible and fixable in position so that the user does not have to hold the external air outlet conduit 106 in a selected position while drying the craft 12 (FIG. 12). For example, the external air conduit 106 may be made from corrugated polymeric tubing that is flexible and that is fixable in position, similar to the tubing that is sold under the trade name Pop Toobs™, which is sold by Poof-Slinky, Inc.

The external air conduit 106 may additionally be collapsible or extendible to permit greater range of movement of its outlet end, shown at 109. Referring to FIG. 10, the external air conduit shown at 106a is shown in its collapsed state. The external air conduit shown at 106b is shown in an extended state.

While it is shown in FIG. 10 to provide two air outlet conduits 98, it is alternatively possible to provide some other number of air outlet conduits 98, such as, for example, one air outlet conduit 98, or three or more air outlet conduits 98.

The electrical conduit 96 may be supplied electricity from any suitable source, such as, optionally, a battery pack 110, or optionally from an electrical receptacle (not shown). A switch 111 may be provided on the housing 80 to control the operation of the fan 92.

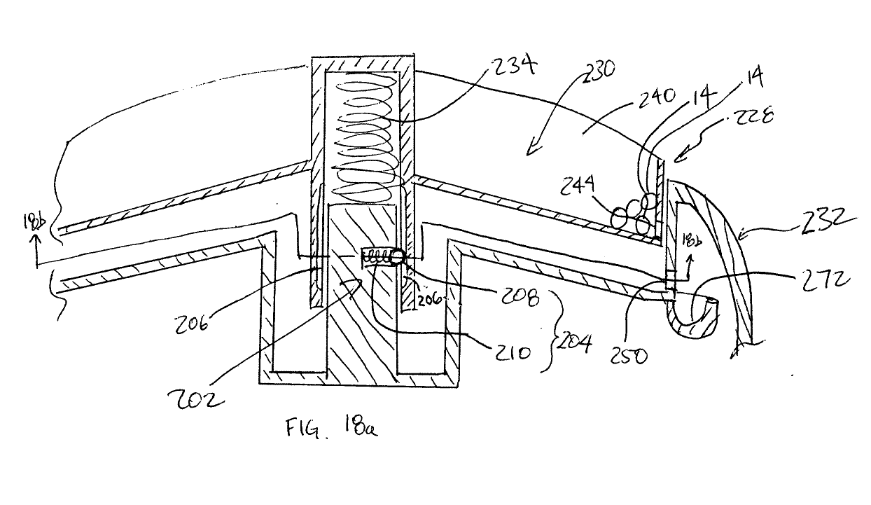

It is alternatively possible to provide a bead craft drying system 24 that comprises a hand-held, battery-powered fan, as shown at 200 in FIG. 17, that is a separate accessory.

Referring to FIG. 1, each external air conduit 106 may be provided with a bead craft gripper 112, thereby forming a bead craft holder 26. The bead craft holder 26 is thus made up of the gripper 112 and the external air conduit 106, which acts as a gripper arm 114. The gripper arm 114 is configurable to position the gripper 112 in a plurality of positions.

In embodiments where two bead craft holders 26 are provided, as shown in FIG. 1, for example, it is optionally possible to position one bead craft holder 26 on one side of the bead craft work area 18 and one bead craft holder 26 on the opposite side of the bead craft work area. It is alternatively possible to provide only a single bead craft holder 26, instead of two bead craft holders 26. In an embodiment wherein only one bead craft holder 26 is provided the housing 80 may have only a single mounting point for it, or alternatively the housing 80 may have two or more mounting points 116 (see FIG. 8) that can be selected by the user to hold the gripper arm 114. In embodiments wherein the gripper arm 114 is an external air outlet conduit 106, one or more of the mounting points 116 may be the air outlet ports 104. Additionally or alternatively, it is possible to provide mounting points 116 that are not air outlet ports 104 and that do not therefore convey air (not shown).

Reference is made to FIG. 12, which shows the bead craft holder 26 in use. The bead craft holder 26 may be used to hold a first bead craft 12a, adjacent a second bead craft 12b in the bead craft work area 18, so that the two bead crafts 12a and 12b can be joined together. (eg. by wetting and subsequently drying). By providing the bead craft holder 26, the user does not have to personally hold the first bead craft 12a in position while it is being joined with the second bead craft 12b.

The gripper 112 may have any suitable configuration. In embodiments wherein the gripper arm 114 is the external air conduit 106, it is preferable that the gripper 112 may have a sufficiently open structure that it permits air from the conduit 106 to flow therepast and helps to dry the craft 12a held by the gripper 112.

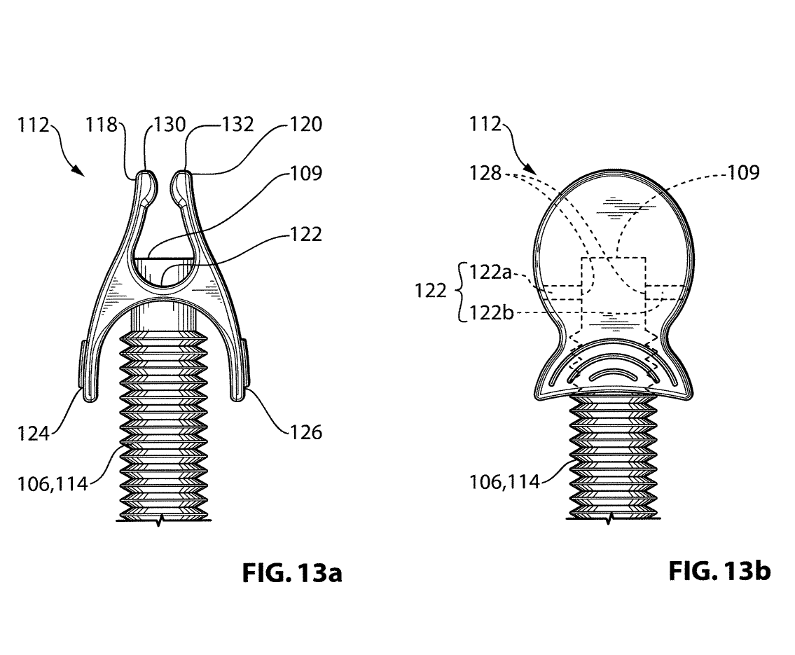

An exemplary embodiment for the gripper 112 is shown in FIGS. 13a and 13b. Referring to FIG. 13a, the gripper 112 includes a first jaw 118 and a second jaw 120, which are joined by a hinge 122, which may be a living hinge. The first and second jaws 118 and 120 may be biased towards a rest position whereat they are proximate each other but not touching each other. First and second finger holds 124 and 126 are provided to provide a place for the user to put their fingers when opening the gripper 112. The gripper 112 further includes a gripper arm mounting ring 128 (FIG. 13b) for removably mounting onto the outlet end 109 of the external air conduit 106/gripper arm 114. It will be apparent that the structure of the gripper 112 is such that there is a substantially unobstructed air flow path from the outlet end 109 of the external air conduit 106 to the respective forward ends 130 and 132 of the jaws 118 and 120. A contributing factor to having an unobstructed air flow path is that the hinge 122 is split into two hinge portions 122a and 122b (see FIG. 13b), which are positioned at the side edges of the gripper 112, and which in part define the gripper arm mounting ring 128. Another contributing factor to the unobstructed air flow path is that the first and second jaws 118 and 120 are spaced from each other by the hinge 122 (see FIG. 13a), such that only their respective forward ends 130 and 132 are positioned proximate each other.

Referring to FIG. 1, the bead craft work area 18 is an area of the bead craft system 10 that is usable for the production of a bead craft 12. The bead craft work area 18 may include a planar bead craft tray 134 that sits in and is removable from a planar bead craft tray receptacle 136. The planar bead craft tray 134 includes a planar bead craft form 137 including bead locating features 138, such as dimples, or projections, that facilitate a uniform positioning of the beads 14 into a desired planar pattern, such as a rectangular array, wherein the beads 14 are organized into rows and columns.

The planar bead craft tray 134 is removable from the bead craft work area 18. This permits a first bead craft 12 to be removed from the bead craft work area 18 (eg. for drying), and another bead craft 12 can be produced in the bead craft work area 18. For example, a second planar bead craft tray 134 could optionally be provided (not shown) and could be placed in the bead craft work area 18 for use in producing a second bead craft 12. It will be noted that if a user removes from the bead craft work area 18 a planar bead craft tray 134 holding a bead craft 12 needing to be dried and sets the planar bead craft tray 134 down next to the rest of the bead craft system 10, the bead craft drying system 24 could still be used to dry the bead craft 12, by bending outwards the flexible external air conduit 106. Thus the bead craft system 10 is capable of drying a first bead craft 12 while simultaneously permitting a user to make a second bead craft 12 in the bead craft work area 18.

It is alternatively possible to provide a planar bead craft form 137 that is fixedly positioned in the bead craft work area 18, instead of being positioned on the removable planar bead craft tray 134.

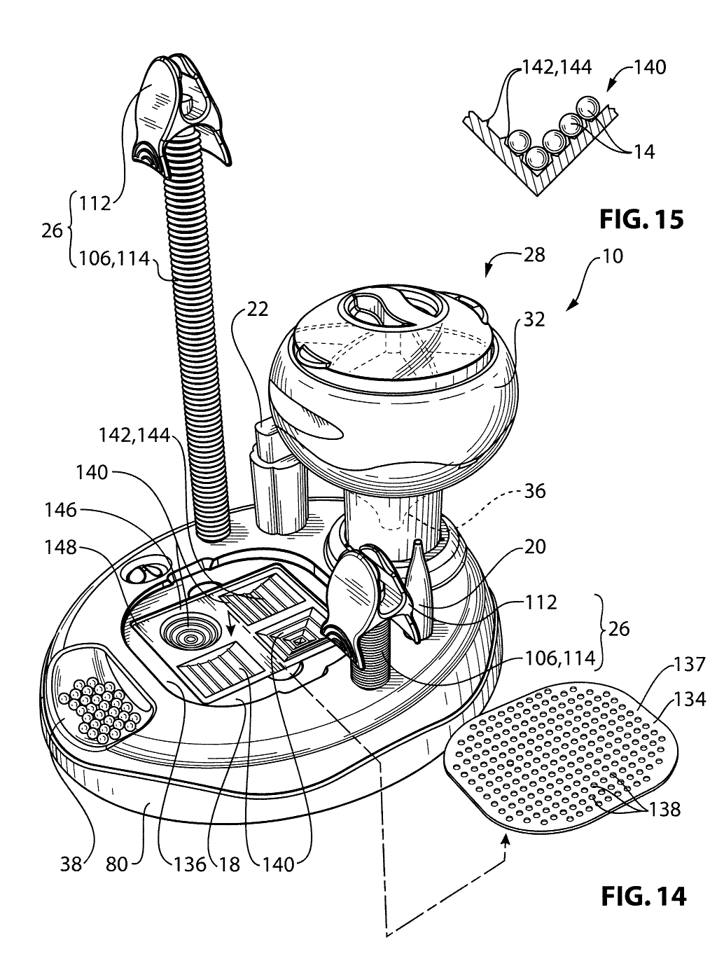

Referring to FIG. 14, in embodiments wherein the removable planar bead craft tray 136 is provided, the bead craft work area 18 may include one or more three-dimensional bead craft forms 140 underneath the removable planar bead craft tray 134. In the embodiment shown in FIG. 14, there are four three-dimensional bead craft forms 140.

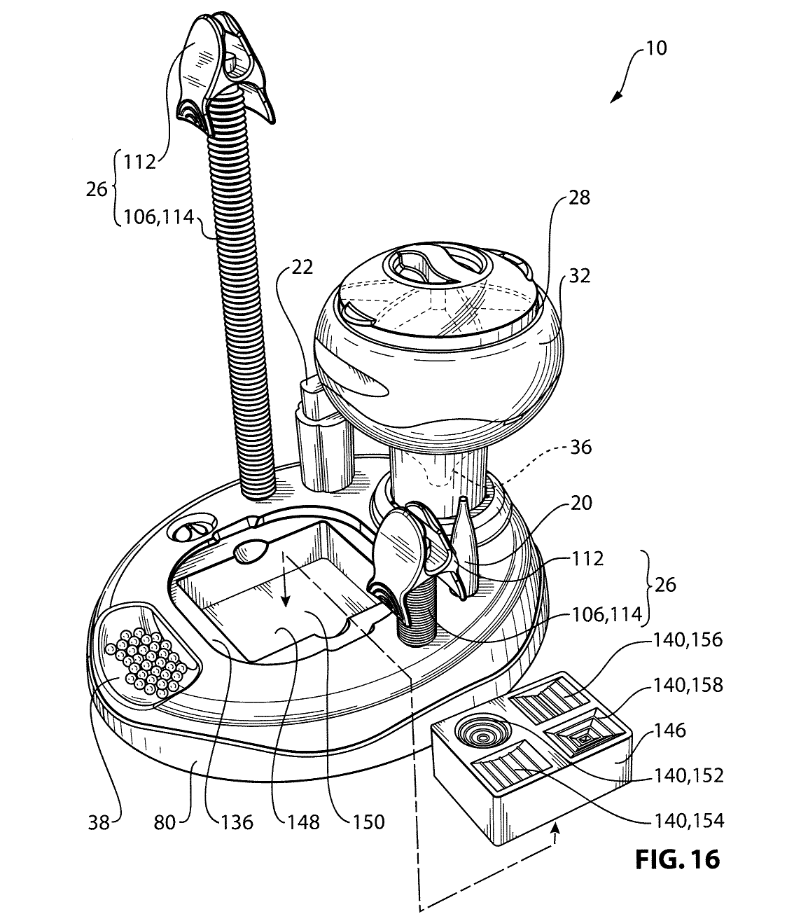

The three-dimensional bead craft forms 140 may include bead locating features 142 thereon, which assist in the uniform placement of beads 14 in the forms 140. The bead locating features 142 may be similar to the bead locating features 138, or they may have a different configuration. For example, the bead locating features 142 may include curvilinear projections 144 (see FIG. 14) that act as delimiters between adjacent bead rows (see FIG. 15). The projections 144 may assist in supporting beads 14 in their respective rows, since each row of beads 14 may have a different elevation than the rows of beads on either side of it.

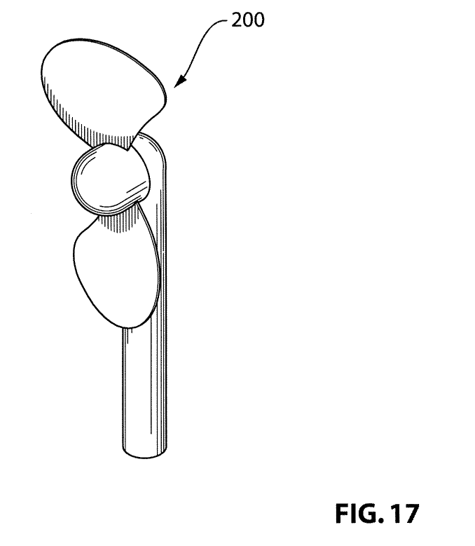

The three-dimensional bead craft forms 140 may be positioned on (eg. molded in as part on a three-dimensional bead craft tray 146 that sits in and is removable from a three-dimensional bead craft tray receptacle 148. Referring to FIG. 16, the three-dimensional bead craft tray receptacle 148 may additionally form another three-dimensional bead craft form 150 that is not included in the three-dimensional bead craft tray 146. For example, the three-dimensional bead craft forms 140 in the tray 146 may include a hemisphere form 152, a half-cylinder form 154, a roof form 156 and a pyramid form 158, while the bead craft form 150 may be a box form.

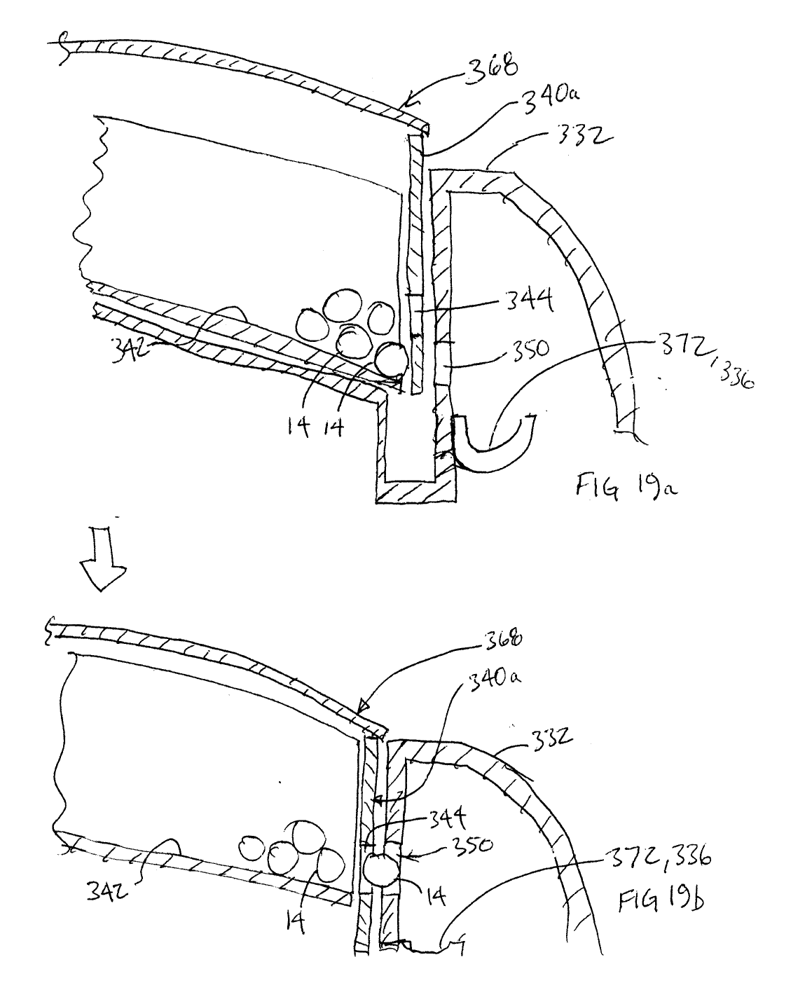

In the embodiment shown in FIGS. 3a and 3b, the entire bead storage unit 28 is pressed downwards to bring the chamber outlet aperture 44 in the storage chamber-defining wall 40a in alignment with the inlet 50 to the bead outlet conduit 36. However, it is alternatively possible to have an embodiment (see FIGS. 19a and 19b) wherein only the wall 340a that has the chamber outlet aperture 344 moves downwards to bring the chamber outlet aperture 344 into alignment with the inlet 350 of the bead outlet conduit, which is provided in the bead storage unit support 332 (see FIG. 19b). In such an embodiment, the chamber outlet aperture 344 would initially be elevated relative to the floor 342 of the bead storage chamber 330 (FIG. 19a), and downward movement of the wall 340a would bring the chamber outlet aperture 344 down to the level of the bead chamber floor 342 for permitting the pass-through of beads 14 (FIG. 19b) through the chamber outlet aperture 344, through the inlet 350 of the bead outlet conduit 336 and onto the ramp 372. In the embodiment shown in FIGS. 19a and 19b, the cover 368 also moves downward along with the wall 340a.

While the above description constitutes a plurality of embodiments of the present invention, it will be appreciated that the present invention is susceptible to further modification and change without departing from the fair meaning of the accompanying claims.

1. A bead storage and dispensing device, comprising:
a bead storage chamber having a bead storage chamber wall defining a chamber outlet aperture; and
a bead outlet conduit external to the bead storage chamber wall, the bead outlet conduit having an inlet, wherein the bead storage chamber wall is movable between an unaligned position wherein the chamber outlet aperture is unaligned with the inlet of the bead outlet conduit to prevent the release of beads from the bead storage chamber, and an aligned position wherein the chamber outlet aperture is aligned with the inlet of the bead outlet conduit to permit the release of at least one bead from the bead storage chamber.

2. A bead storage and dispensing device as claimed in claim 1, wherein the entire bead storage chamber is movable between the unaligned and aligned positions.

3. A bead storage and dispensing device as claimed in claim 1, wherein the bead storage chamber wall is biased towards the unaligned position.

4. A bead storage and dispensing device as claimed in claim 1, wherein the bead storage chamber has a bead storage chamber floor, wherein the bead storage chamber floor proximate the chamber outlet aperture is sloped to direct beads towards the bead outlet aperture,
and wherein the bead dispensing system further comprises an anti-bridging member, wherein, when the bead storage chamber wall is in the aligned position, the anti-bridging member extends into the bead storage chamber and cooperates with the bead storage chamber wall to define a bead discharge chamber at the chamber outlet aperture, wherein the bead discharge chamber is configured to hold any beads contained therein in a position that inhibits bridging of beads at the chamber outlet aperture, and wherein, when the bead storage chamber wall is in the unaligned position, the anti-bridging member is at least substantially withdrawn from the bead storage chamber.

5. A bead storage and dispensing device as claimed in claim 4, wherein the bead discharge chamber is sufficiently narrow to prevent two beads from being horizontally adjacent each other at the chamber outlet aperture.

6. A bead storage and dispensing device as claimed in claim 1, wherein the bead storage chamber is a first bead storage chamber, wherein the bead storage and dispensing device include a bead storage unit that includes a second bead storage chamber, each bead storage chamber having a bead storage chamber wall defining a chamber outlet aperture, wherein the bead storage unit is movable to bring a selected one of the bead storage chamber walls to the aligned position.

7. A bead storage and dispensing device as claimed in claim 1, wherein the bead storage chamber is a first bead storage chamber, wherein the bead storage and dispensing device include a bead storage unit that includes a second bead storage chamber, each bead storage chamber having a bead storage chamber wall defining a chamber outlet aperture, wherein the bead storage unit is rotatable to select one of the bead storage chambers from which to dispense one or more beads.

8. A bead craft system, comprising:
a housing having a bead craft work area;
a fan within the housing; and
an air outlet conduit connectable to the housing and in fluid communication with and downstream from the fan for use in drying a craft, wherein the conduit is movable to a plurality of positions.

9. A bead craft system as claimed in claim 8, wherein the air outlet conduit is flexible and is positionable and self-supporting in a plurality of positions.

10. A bead craft system as claimed in claim 8, wherein the conduit has an outlet end, and the bead craft system further comprises a gripper that is mountable to the conduit for holding a bead craft in proximity to the outlet end.

11. A bead craft system as claimed in claim 10, wherein the gripper includes a pair of jaws each jaw having a forward end, and is configured to mount to the outlet end of the conduit, and is free of obstructions between the outlet end of the conduit and the forward ends of the jaws.

12. A bead transfer device comprising a bead transfer device body defining an interior volume, wherein the bead transfer device body is deformable to reduce the volume of the interior volume, and is resilient, the bead transfer device body having a single opening, wherein the opening is sized and shaped to form a seal on one of the beads.

13. A bead transfer device as claimed in claim 12, wherein the bead transfer device body is integral.

14. A bead transfer device as claimed in claim 12, wherein the beads have a bead diameter and wherein the opening is positioned on a bead transfer device tip, wherein the bead transfer device tip has a tip diameter that is at most equal to the bead diameter.

15. A bead craft system, comprising:
a housing having a bead craft work area, the bead craft work area including a planar bead craft tray configured to receive beads for producing a planar bead craft, wherein the housing includes a three-dimensional bead craft form positioned underneath the planar bead craft form, wherein the three-dimensional bead craft form is configured to receive beads for the formation of a three dimensional bead craft.

16. A bead craft system as claimed in claim 15, wherein the three-dimensional bead craft form is positioned on a three-dimensional bead craft tray, and the housing includes a three-dimensional bead craft tray receptacle under the planar bead craft tray, and wherein the three-dimensional bead craft tray is removable from the three-dimensional bead craft tray receptacle.

17. A bead craft system as claimed in claim 16, wherein the three-dimensional bead craft form is a first three-dimensional bead craft form, and wherein the three-dimensional bead craft tray receptacle is shaped to be a second three-dimensional bead craft form that has a different shape than the first three-dimensional bead craft form.

18. A bead craft system, comprising:
a housing having a bead craft work area including a bead craft work area; and
at least one bead craft holder connected to the housing, wherein each bead craft holder includes a gripper and a gripper arm, wherein the gripper arm is configurable to position the gripper in a plurality of positions.

19. A bead craft system as claimed in claim 18, wherein the gripper arm is an air flow conduit and has an inlet end and an outlet end, wherein the bead craft system further comprises a fan in the housing, wherein the housing includes an air outlet port in fluid communication with the fan and wherein the air outlet port is configured to receive the inlet end of the gripper arm,
wherein the gripper and the outlet end of the gripper arm cooperate to permit airflow to discharge from the air flow conduit to reach at least any bead craft held by the gripper.
